(19) United States
(12) Patent Application Publication
(10) Pub. No.: US 2008/0281652 A1
(43) Pub. Date: Nov. 13, 2008

(54) METHOD, SYSTEM AND PROGRAM PRODUCT FOR DETERMINING AN OPTIMAL INFORMATION TECHNOLOGY REFRESH SOLUTION AND ASSOCIATED COSTS

(75) Inventors: Mickey Iqbal, Tucker, GA (US); Frances F. Wand, Coming, NY (US)

Correspondence Address: SILVY ANNA MURPHY, 100 TURNBERRY LANE, CARY, NC, 27518, US

(73) Assignee: International Business Machines Corporation, Armonk, NY (US)

(21) Appl. No.: 11/746,782

(22) Filed: May 10, 2007

(51) Int. Cl. G06Q 10/00

(52) U.S. Cl. 705/7

(57) ABSTRACT

A method, system and program product for determining an optimal information technology refresh solution and associated costs for implementing the information technology refresh solution in a business. The method includes deploying on a computer system an information technology refresh solution tool that is configured to determine an optimal information technology refresh solution based on business-technical data and/or business rules stored in a data repository. The method further includes updating the stored business-technical data and/or business rules based on one or more business-technical requirements, including any existing business constraints and any prospective business constraints and prioritizing the business-technical data updated to determine the optimal information technology refresh solution, such that, the optimal information technology refresh solution determined can be implemented in the business. Further, the method includes calculating, using the information technology refresh solution tool, an estimation of operational costs for implementing the optimal information technology refresh solution determined.

### FIELD OF THE INVENTION

The present invention relates to a method, system and computer program product for determining an optimal information technology refresh analysis solution or analysis result for renewing and/or updating and/or revising an existing information technology infrastructure solution used in a business. In particular, the present invention relates to a method, system and computer program product for developing or determining a comprehensive and optimal information technology refresh analysis result or solution and associated operation costs, using a computer tool or code deployed or installed on a computer system for renewing and/or updating and/or revising and/or upgrading the existing information technology infrastructure or solution used in a business.

### BACKGROUND OF THE INVENTION

In today's business environment, an organization and/or business has to invest considerable resources in developing and/or maintaining an information technology solution or infrastructure for operating a business. Accordingly, a reasonably accurate and up-front estimate of the costs associated with developing a new replacement and/or updating an existing information technology infrastructure can provide an organization and/or business with a competitive advantage in the proposal development and approval process, and also prevent costly price overruns and implementation delays. As such, there is a need for an efficient way to replace and/or update and/or revise an existing information technology solution used in a business.

### SUMMARY OF THE INVENTION

In a first aspect of the invention, there is provided a method of using a computing system to determine an optimal upgrade to an information technology infrastructure for implementation in a business. The method includes deploying on the computer system an information technology upgrade analysis or refresh services tool including a data repository and configured to determine the optimal upgrade to an information technology infrastructure, and inputting into the data repository a plurality of business rules and a plurality of business-technical data for the existing information technology solution used in the business. The method further includes storing, in a data repository within a computing system, a plurality of business rules and a plurality of business-technical data that are inputted into the computing system for an existing information technology solution used in a business, updating one or more of the plurality of business rules and the plurality of business-technical data stored in the data repository within the computing system to determine an optimal upgrade to the information technology infrastructure for implementation in the business. The method further includes prioritizing one or more of the plurality of business-technical data updated in the data repository based on one or more business-technical requirements, including any existing business constraints and any prospective business constraints and determining the optimal upgrade to the information technology infrastructure, using the plurality of business rules updated in the data repository and using the plurality of business-technical data updated in the data repository, wherein the optimal upgrade to the information technology infrastructure can be implemented in the business. Further, the method includes calculating, using the computer system, an estimation of operational costs for implementing the optimal information technology upgrade or refresh analysis result determined. Furthermore, the method includes generating one or more operational cost estimation reports based on the estimation of operational costs calculated for implementing the optimal upgrade to the information technology infrastructure determined for the business. In an embodiment, the determining step further includes loading the plurality of business-technical data updated and the plurality of business rules updated into a first or a solution analysis component of the information technology upgrade or refresh analysis tool deployed on the computing system for determining the optimal upgrade solution to the information technology infrastructure and running an analysis, using the first analysis component of the information technology upgrade or refresh analysis tool deployed on the computing system for determining the optimal upgrade to the information technology infrastructure for the business. In an embodiment, the determining step further includes re-prioritizing the one or more of the plurality of business-technical data updated in the data repository and re-running an alternate analysis, using the first analysis component of the information technology upgrade or refresh analysis tool deployed on the computing system for determining an alternative optimal upgrade to the information technology infrastructure for the business. Further, the calculating step further includes inputting, into a second or cost analysis component of the information technology upgrade or refresh analysis tool deployed on the computing system, cost estimation data for the existing information technology solution used in the business, inputting into the second analysis component any additional cost estimation data for the optimal information technology upgrade or refresh analysis result determined for the business and using the cost estimation data and any additional cost estimation data for calculating the estimation of operational costs for implementing the optimal information technology upgrade or refresh analysis result determined for the business.

In another aspect of the invention, there is provided a computer system for determining an optimal information technology upgrade or refresh analysis result for implementation in a business. The computer system includes an information technology refresh services tool configured to determine an optimal upgrade to an information technology infrastructure for implementation in a business, the information technology refresh services tool further includes a user interface component configured to receive input from an end user as to a plurality of business-technical data associated with the business, one or more of the plurality of business-technical data inputted being prioritized by the end user based on one or more business-technical requirements, including any existing business constraints and any prospective business constraints, the user interface component being further configured to receive input as to a plurality of business rules used in the business. Further, the system includes a data repository component configured to store the plurality of business-technical data received from the end user, the data repository component being further configured to store the plurality of business rules used in the business, a first analysis component configured to determine the optimal upgrade to the information technology infrastructure for the business using the business-technical data inputted and prioritized by the end user and using the business-technical requirements inputted for the business and a second analysis component configured to calculate corresponding operational costs for the optimal upgrade to the information technology infrastructure determined by the first analysis component using the business-technical data and the business rules stored in the data repository component, wherein the information technology upgrade or refresh analysis tool is configured to provide a controlled and a secure programming interface between each of the user interface component, the data repository component, the first analysis component, the second analysis component and one or more external systems. In an embodiment, the first analysis component is further configured to utilize an assumption based truth maintenance system for determining the optimal upgrade to the information technology infrastructure that can be implemented in the business, the first analysis component being configured to backtrack an initial set of assertions used in determining the optimal upgrade to the information technology infrastructure for determining an alternate optimal information technology upgrade or refresh analysis result. In an embodiment, the first analysis component is further configured to identify criticality for one or more of the plurality of business-technical data inputted by the end user based on the one or more business-technical requirements used to prioritize the one or more of the plurality of business-technical data in order to determine the optimal upgrade to the information technology infrastructure for implementation in the business. In an embodiment, the data repository component is further configured to receive updates for the plurality of business-technical data and for the business rules stored therein. In an embodiment, the second analysis component is further configured to calculate the corresponding operational costs using functions and formulas that calculate transition costs and steady state costs associated with the optimal upgrade to the information technology infrastructure determined for implementation in the business.

In yet another aspect of the invention, there is provided a computer program product for determining an optimal upgrade to the information technology infrastructure for implementation in a business. The computer program product includes a computer readable medium and first program instructions to store input data into a data repository within a computing system, the input data including a plurality of business-technical data and business rules. Further, the computer program product includes second program instructions to select a priority rating for one or more of the plurality of business-technical data based on one or more business-technical requirements for the business, including any existing business constraints and any prospective business constraints and third program instructions to determine an optimal upgrade to the information technology infrastructure using the priority rating selected for the one or more of the plurality of business-technical data and using the plurality of business rules updated in the data repository and to calculate an estimation of operational costs for implementing the optimal upgrade to the information technology infrastructure determined in the business. The computer program product further includes fourth program instructions to generate reports to an end user itemizing the optimal information technology upgrade or refresh analysis result determined and to generate reports for the estimation of operational costs calculated for implementing the optimal upgrade to the information technology infrastructure determined in the business. In an embodiment, the first program instructions include instructions to update the plurality of business rules stored in the data repository and wherein the first program instructions include instructions to update one or more of the plurality of business-technical data stored in the data repository. In an embodiment, the second program instructions include instructions to automate adjustments to the priority ratings selected when any inconsistencies are detected among the priority rating selected for the one or more of the plurality of business-technical data for determining the optimal upgrade to the information technology infrastructure for the business. Further, in an embodiment, the third program instructions include instructions to backtrack an initial set of assertions used in determining the optimal upgrade to the information technology infrastructure and to re-determine an alternate optimal upgrade to the information technology infrastructure for implementation in the business when any adjustments are made to the priority ratings selected for the one or more of the plurality of business-technical data and to recalculate a corresponding alternate estimation of operational costs for implementation of the alternate optimal upgrade to the information technology infrastructure in the business.

In an embodiment, the plurality of business-technical data includes at least one of cost, performance, network bandwidth, length of equipment lease streams, license costs, transaction volumes, input/output requirements, CPU and processing requirements, floor space requirements, power requirements, server consolidation requirements and ability to effectively execute the optimal upgrade to the information technology infrastructure and wherein the business-technical requirements includes at least one of current server CPU, current memory, current disk storage, current network interface configuration, current test environment, current production environment, minimal server CPU, optimal server CPU, minimal memory, optimal memory, minimal disk storage, optimal disk storage, minimal network interface configuration, optimal network interface configuration, application software configuration on a server, middleware package configuration on the server, system software configuration on the server, version, release and license type for operating system on the server, version, release and license type for each application software package, version, release and license type for each middleware package, version, release and license type for each system software package, anticipated application usage peak hours, anticipated application usage peak days, anticipated application usage special pattern, anticipated application usage peak to average ratio of application usage, criticality of application, population of users, location of users, type of network connection used by users to access the application, anticipated growth of application usage at different times, location of data center where the server will be placed, type of service offerings to be used, type of infrastructure models that an application will use, desired date that the optimal upgrade to the information technology infrastructure needs to be implemented and desired formats for the operational cost estimation reports. In an embodiment, each of the first, second, third and fourth program instructions are recorded on the computer readable medium.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a flowchart which outlines the process of inputting and/or entering business data, technical data and/or business rules into a TRS (Technology Refresh Services) data repository, which is configured to store the data and/or rules inputted and/or entered, in accordance with an embodiment of the present invention.

FIGS. 2A and 2B together depict a flowchart outlining the steps involved in determining an optimal upgrade to an information technology infrastructure and the associated operational costs for implementing the optimal upgrade to the information technology in a business, in accordance with an embodiment of the present invention.

FIG. 3 depicts a Technology Refresh Services (TRS) system for determining an optimal upgrade to an information technology infrastructure and the associated operational costs for implementing the optimal upgrade determined in a business, in accordance with an embodiment of the present invention.

FIG. 4 is a schematic block system diagram illustrating an embodiment of a computer infrastructure for determining an optimal upgrade to an information technology infrastructure and the associated operational costs for implementing the optimal upgrade determined in a business, in accordance with an embodiment of the present invention.

### BEST MODE FOR CARRYING OUT THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

In one embodiment, the invention provides a method of using a tool or code deployed or installed on a computing system to determine an optimal upgrade to an information technology infrastructure or an optimal information technology refresh services (TRS) solution and the associated operational costs for implementing in a business the optimal information technology refresh solution or optimal upgrade to the information technology determined. As used herein, the phrase “information technology refresh services (TRS) solution” or “optimal upgrade to an information technology infrastructure” or “TRS solution analysis results” refers to the information technology solution or result determined through analysis using an information technology upgrade analysis tool, preferably, an information technology refresh services (TRS) tool or TRS (technology refresh services) tool or TRS tool or code. In an embodiment, the TRS (Technology Refresh Service or Services) tool is a program deployed or installed on a computing system that is configured to determine an optimal upgrade solution to an information technology infrastructure when renewing and/or refreshing and/or updating and/or revising and/or upgrading an existing information technology infrastructure for implementation in a business. In particular, the TRS tool refers to the computing tool or code or program that employs TRS (Technology Refresh Service or Services), which refers to a system of comprehensive services for sizing and forecasting an optimal upgrade solution to an information technology infrastructure and the associated operational costs for implementing an optimal upgrade solution to the information technology infrastructure when renewing and/or refreshing and/or updating and/or upgrading and/or revising an existing information technology solution used in a business. The technology refresh services (TRS) system takes into account other factors, such as, human resources (labor), business processes and facilities, to ensure that the information technology refresh analysis result developed meets the business goals and/or technical challenges in the most efficient manner. In an embodiment, the invention provides a computer based method, using the Technology Refresh Services (TRS) tool or code, for determining an optimal upgrade solution to the information technology infrastructure or a refresh analysis result for the information technology infrastructure as well as providing a reasonably accurate estimate for implementing the upgrade or refresh solution or analysis result in a business, taking into account a plurality of required technical data and/or requirements and business data and/or requirements (referred to herein as business-technical data) that are supplied by an organization or business or a person (herein referred to as the “owner” or “end user”) considering developing and implementing an information technology refresh service or services solution or upgrading an existing information technology infrastructure using a Technology Refresh Service or Services (TRS) system.

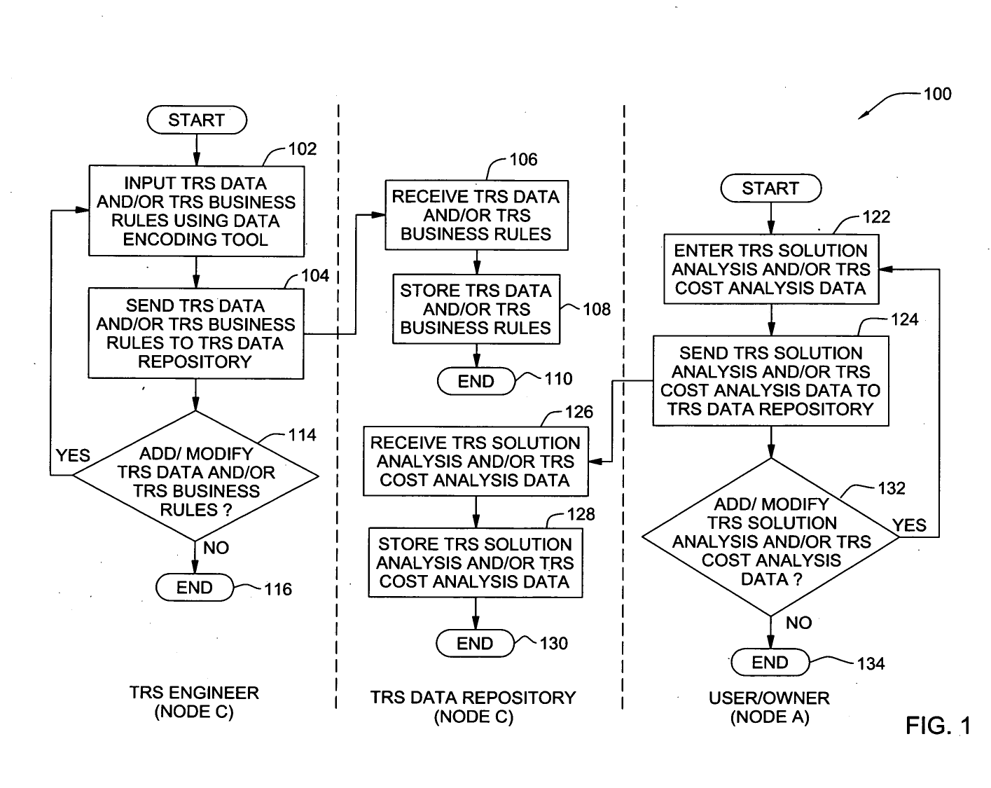

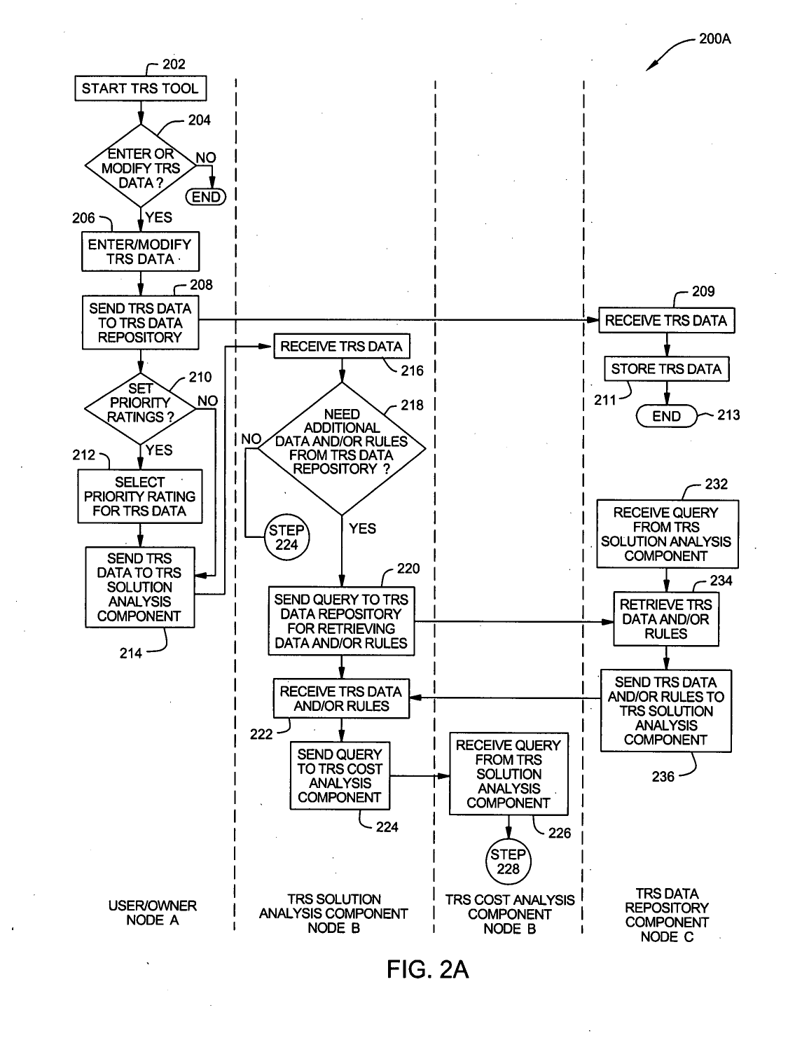

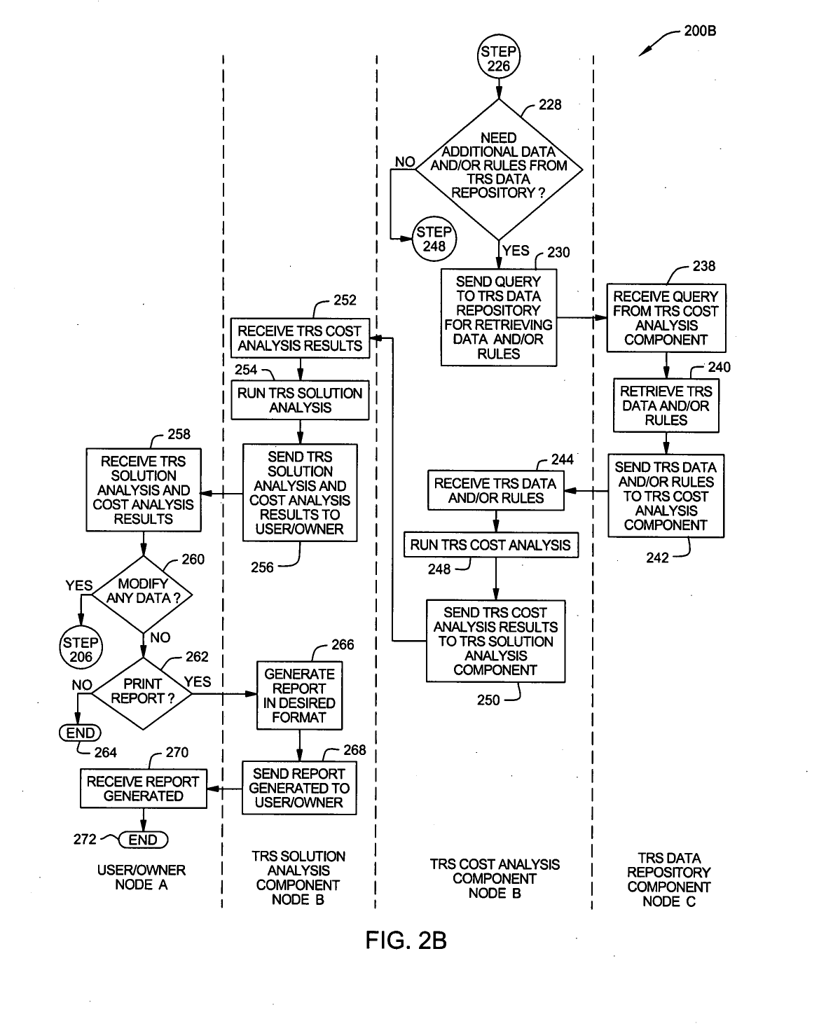

Reference is now made to FIGS. 1 and 2, which together illustrate a computer based method of determining an optimal upgrade solution or a refresh service solution to an information technology infrastructure as well as the associated operational costs for implementing the optimal information technology upgrade or TRS solution determined. Turning to FIG. 1, reference numeral 100 illustrates a method of providing a data repository or an expert system that stores relevant business-related facts and/or data (often referred to herein as simply “data” or “factual data” or “TRS data” or “business-technical data”) needed for determining an optimal upgrade solution or a refresh service solution to an information technology infrastructure for implementation in a business when renewing and/or updating and/or revising and/or renewing and/or refreshing and/or updating and/or revising an existing information technology solution used in the business, in accordance with an embodiment of the invention. As shown in the flowchart 100, a Technology Refresh Services (TRS) engineer or engineering team (referred to herein as simply TRS engineer), inputs or enters in step 102 relevant TRS factual data and/or business rules used in a particular business into a TRS data repository, which in an embodiment, comprises an expert system that utilizes artificial intelligence. In an embodiment, the TRS engineer utilizes a data encoding tool deployed on a computing system, for instance node C, which in an embodiment also includes the TRS data repository, as shown in FIG. 1. As used herein, a “business rule” is any rule that is used or applied in a given situation in the business, such as, increase physical server storage space by a certain amount or percentage if a new server is added, etc. Accordingly, all the relevant TRS data and business rules relevant for determining an optimal upgrade solution or a refresh service solution to an information technology infrastructure for implementation in a given business are sent in step 104 by the computing system at node C to a TRS data repository for storage. In an embodiment, the TRS data repository is located within node C of the computing system. The TRS data repository receives the TRS data and/or business rules in step 106 and stores in step 108 the TRS data and/or business rules in the data repository, ending the process in step 110. Further, the TRS engineer or engineering team makes a determination in step 114 as to whether or not the TRS data and/or TRS business rules are to be added and/or modified. If the TRS engineer or engineering team decides to add or modify the TRS data and/or TRS business rules, then the process returns to step 102, where the TRS engineer inputs and/or modifies the TRS data and/or TRS business rules and the steps 104 through 114 are repeated, as necessary, until no addition and/or modification of TRS data and/or TRS business rules is needed, ending the process at step 116. Further, as shown in FIG. 1, a user and/or owner at a separate computing station in the computing system, for instance, node A, can also enter in step 122 TRS data, such as, business-technical data relevant for implementing a TRS analysis result when renewing and/or refreshing and/or updating and/or revising an existing information technology solution. The computing station at node A sends in step 124 the TRS data to the TRS data repository located at node C, which is received by the TRS data repository in step 116. The TRS data repository stores in step 118 the TRS data entered by the user and/or owner, ending the process at step 120. Further, in step 132, the user and/or owner determines whether or not to add additional TRS data and/or modify any existing TRS data entered. If the user and/or owner decides to add additional TRS data and/or modify any entered TRS data, the process returns to step 122 and step 124 through 132 are repeated as necessary, until there are no addition and/or modification of TRS data and/or TRS business rules is needed, ending the process at step 134. In an embodiment, the TRS engineer or engineering team, are TRS domain experts with respect to the different data stored in the TRS data repository or expert system. The TRS data repository component provides an integrated data repository, which stores facts, business rules, and data pertaining to all TRS related knowledge domains, historical measurements data from previous similar operational efforts, and also includes facts and business rules related to expertise in the utilization of any given combination of components (hardware, software, facilities, etc.) for determining an optimal upgrade solution or a technology refresh service (TRS) solution to an information technology infrastructure information technology upgrade or refresh or refresh analysis result when renewing and/or replacing and/or updating and/or revising and/or refreshing an existing information technology solution. In an embodiment, the TRS data repository also contains a data processing engine which performs data management operations on the data stored within the repository.

In an embodiment, the TRS data repository or component stores facts and/or data, for example, hardware lease cost of hardware manufactured by a vendor per month over a lease lifetime, length of hardware lease for a particular storage device in number of months, hardware maintenance cost per year for a particular server, monthly disk storage charge per supplier, network per port charge for port of a certain size, effort required (in hours) to collect and analyze server statistics with medium complexity by worker of intermediate skill level, effort required (in hours) to collect and analyze server statistics with medium complexity by worker of expert skill level, CPU and speed required by an application of a particular vendor, TRS tool-set A can provide server hardware platform/CPU configuration conversion based on the industry standard of CPU performance rating, TRS tool-set B can provide statistics of the application CPU, memory, disk storage usage, network I/O and current configuration, software vendor's application package series K are not certified on hardware Vendor H series servers, data centers at locations A and B are capable of supporting high density server platforms, such as blade centers, and the structure support and cooling specifications allows the data centers to host shark storage servers, data centers at locations C and D, can only support the servers able to going into rack type X with at most Y height, shared SAN storage, etc. Similarly, the TRS data repository contains business rules, which are encoded within the data repository using a computer programming language which facilitates the computer based representation of business rules and their processing by a data management engine within the data repository component.

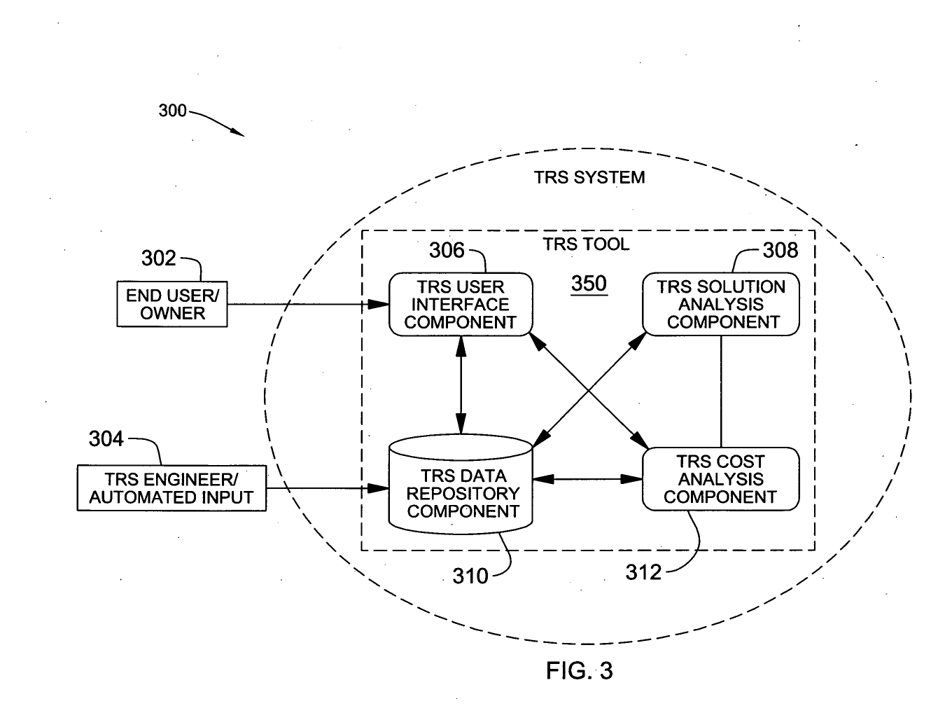

Accordingly, as shown in FIG. 1, the TRS engineering team feeds all the required data, facts and business rules into the TRS data repository using a data encoding tool. An update of the information (facts, data, business rules, etc.) stored in the TRS data repository by the TRS engineering team can be made on an as needed basis or at predefined periods in time. The updates can be made using an electronic file transfer over the network or using any type of electronic storage media (such as CD, DVD, floppy diskette, etc.). The periodic updates ensure the currency of the facts, data and business rules stored within the data repository. Further, as shown in FIG. 1, an owner and/or end user enters business-technical data for implementing a TRS analysis result, that is, a plurality of business related data and/or technical requirements for the business, using a user interface component of a Technology Refresh Services (TRS) tool, as discussed further herein below with respect to FIG. 3. In an embodiment, the required technical and business data for which the owners input is solicited include, for example, current server CPU, memory, disk storage, and network interface configuration, if application is currently running in an existing environment (test or production environment to be relocated or to be updated); the minimum and optimal server CPU, memory, disk storage and network interface configuration requirements by the software developer/vendor, if the application is new; the anticipated application usage peak hours, peak days, or special usage pattern, what is the anticipated usage peak to average ratio of this application, how critical the application is to the business (providing a list of ratings), application software configuration on the server, including software package, version and release, and license type for the Operating System (OS), application software package, middleware package, system software packages, the characteristics of major application transaction types (such as CPU, memory, or disk I/O intensive or not), user population and their locations, type of network connection that a user will use to access the server, anticipated growth of the application usage with different time horizons, the location of the data center that the server is going to be placed in, the type of service offerings or infrastructure models that the application is going to use, the desired date that the server needs to be provisioned, or go into production, the desired formats for the report, etc. Further, the end user/owner selects or sets forth a priority rating or level for one or more of the business-technical variables supplied based on a set of business-technical factors, such as, cost, performance, network bandwidth, length of equipment lease streams, license costs, transaction volumes for each application, input/output requirements, CPU and processing requirements, floor space requirements, power requirements, server consolidation requirements, and ability to effectively execute an application. As shown in FIG. 1, the TRS data or business-technical data entered by the end user or owner in step 122 is ultimately fed into the TRS data repository component, which is designed to accept the end user's or owner's set of business and technical requirements and to store these requirements in a data format, which in addition, can facilitate further processing of the data.

Turning to FIGS. 2A and 2B, reference numeral 200A and 200B together describe a method or process for determining an optimal upgrade solution or a technology refresh service solution to an information technology infrastructure and the associated operational costs for implementing the optimal information technology upgrade or technology refresh service solution, using the business data, technical data and business rules used in the business that is entered by the end user/owner and/or the TRS engineering team for a business, as discussed with respect to FIG. 1. An owner and/or end user (also referred to as simply user) wanting to determine an optimal upgrade to an information technology infrastructure or a technology refresh solution or a TRS (technology refresh services) analysis, enters the relevant business and technical data (examples of which are described herein above) using a user interface component of a Technology Refresh Services (TRS) tool or TRS tool or information technology upgrade or refresh analysis tool that is deployed on a computing system accessed by the user and/or owner (described further herein below with respect to FIG. 3). In particular, as shown in step 202, the user and/or owner starts the TRS tool in step 202. The tool makes a determination in step 204 as to whether or not the user and/or owner is entering new TRS data or modifying TRS data previously entered into the TRS tool. If the user and/or owner chooses not to enter or to modify TRS data, the process ends at step 205. However, if the user/owner chooses to either enter or modify TRS data, then the TRS tool prompts the user/owner to enter or to modify TRS data in step 206. After the user/owner had entered or modified the TRS data, the TRS data is sent in step 208 to the TRS data repository for storage. The TRS data repository receives the TRS data in step 209 and stores the TRS data in step 211, ending the storing process in step 213. Further, in step 210, the TRS tool determines whether or not the user/owner wants to set or assign or modify priority ratings for the TRS data entered or modified in step 206. If the user and/or owner wants to prioritize or indicate priority with respect to any of the TRS data entered and/or modified, the user and/or owner does so in step 212. On the other hand, if the user and/or owner does not wish to prioritize any of the TRS data entered or modified and/or after the user and/or owner has prioritized the TRS data, then in step 214 the TRS data is sent to the TRS first analysis component (also referred to herein as the first analysis component) of the TRS tool for analysis, so that an optimal upgrade to the information technology infrastructure or technology refresh service solution or TRS solution may be developed for the business based on the TRS data entered by the user and/or owner. The TRS solution analysis component receives the TRS data in step 216 and determines in step 218 whether or not additional data and/or rules are needed from the TRS data repository in order to determine an optimal TRS analysis result for the business. If additional data and/or rules are necessary, the TRS solution analysis component sends in step 220 a query to the TRS data repository for retrieving data and/or rules. The TRS data repository component receives in step 232 the query from the TRS solution analysis component. The TRS data repository component retrieves in step 234 the relevant TRS data and/or TRS business rules requested that are stored within the TRS data repository component and sends in step 236 the TRS data and/or rules to the TRS solution analysis component. The TRS solution analysis component receives in step 222 the TRS data and/or rules and in step 224 sends a query to the TRS cost analysis component (also referred to herein as the second analysis component) to obtain calculated operational costs. Going back to step 218, if no additional TRS data and/or rules are needed, then the process continues at step 224 with the TRS solution analysis component sending a query to the TRS cost analysis component. The TRS cost analysis component receives the query from the solution analysis component in step 226 and the cost analysis component determines in step 228 whether or not additional data and/or rules are needed from the TRS data repository in order to calculate operational costs based on the TRS data provided by the solution analysis component. If additional data and/or rules are necessary, the TRS cost analysis component sends in step 230 a query to the TRS data repository for retrieving data and/or rules. The cost analysis component receives in step 238 the query from the TRS solution analysis component. The TRS data repository component retrieves in step 240 the relevant TRS data and/or TRS business rules requested that are stored within the TRS data repository component and sends in step 242 the TRS data and/or rules to the TRS cost analysis component. The TRS cost analysis component receives in step 244 the TRS data and/or rules and in step 248 the TRS cost analysis component runs a TRS cost analysis for the TRS data provided by the TRS solution analysis component. Going back to step 228, if no additional TRS data and/or rules are needed, then the process continues at step 248 with the TRS cost analysis component running a TRS cost analysis. The TRS cost analysis component sends in step 250 the results of the TRS cost analysis to the TRS solution analysis component, which is received by the TRS solution analysis component in step 252. In an embodiment, the TRS cost analysis component runs a cost analysis using the data or information provided by the user and/or owner, which is evaluated and processed by different functions and formulas stored within the TRS cost analysis component (described herein below with respect to FIG. 3), and the results of the cost analysis are fed back to the solution analysis component and ultimately to the end user/owner via the user interface component. In an embodiment, the TRS solution analysis component runs in step 254 a TRS solution analysis using the results of the TRS cost analysis in order to determine the optimal TRS solution analysis result for upgrading and/or renewing and/or refreshing and/or updating and/or revising an existing information technology solution. The solution analysis component sends in step 256 the TRS solution analysis and the cost analysis results to the user and/or owner. The user and/or owner receives in step 258 the TRS solution analysis and cost analysis results. Further, in step 260, a determination is made as to whether or not the user and/or owner wishes to further modify any of the TRS data in order to obtain a different TRS analysis result. If the user and/or owner wishes to modify any TRS data, the process returns to step 206, and the process steps 206 through 260 are repeated as necessary. If the user and/or owner does not wish to modify any TRS data and/or after the user and/or owner has modified any TRS data, the TRS tool makes an inquiry in step 262 as to whether or not to print a report of the TRS analysis result determined. If a report is not desired or requested, in step 262, the process ends at step 264. However, if a report is desired, the TRS solution analysis component generates in step 266 a report in a desired format and sends in step 268 the report to the user and/or owner. The user and/or owner receives the report in step 270, ending the process at step 272. Accordingly, once the TRS business and technical data or information provided by the user/owner has been stored inside the data repository component, the end user/owner can invoke the TRS tool to perform a solution analysis and/or a cost analysis on a previously generated cost estimate after modifying a few of the business-technical data for the business.

In an embodiment, the owner and/or end user is prompted in step 262 to run or print a report detailing the results of the information technology upgrade solution or technology refresh solution or TRS analysis result as well as the cost analysis results using one or several different reporting options provided by the user interface component of the Technology Refresh Services (TRS) tool. In particular, once all the TRS data has been input, the user interface can be used to generate various types of cost estimation proposal reports in various formats including screen based reports, HTML reports, PDF files, text file reports, CSV file based reports, etc. The reports include various cost accounts broken down by cost categories (hardware, software, labor, etc. for the life-cycle management of the capacity management service. The various types of reports are provided as a result of the inputs fed into the Technology Refresh Services (TRS) tool and the back-end processing performed by other components described in detail further below. The cost data can also be reported in a granular format with reporting categories, such as hardware types, hardware configurations, refresh cycles, application types, deployment costs, on-going steady state costs, overall costs, etc.

Accordingly, using the TRS data repository component or expert system, the right or optimal configuration for implementing a technology refresh service (TRS) analysis result and its costs becomes available right after the owner finishes inputting the data or TRS data into the TRS tool. As an owner fine-tunes or adjusts the priority ratings for one or more business and/or technical data used in the business, the TRS tool re-determines or re-generates an alternate optimal upgrade solution or refresh solution to the information technology infrastructure with different options and re-calculates a set of alternate operational costs associated with the alternate optimal TRS analysis result. Thus, the method provides an end user/owner proposal options with different perspectives, enabling the end user/owner to make better informed decisions. Further, the above method can leverage historical data, for instance, a previous decision regarding implementing a TRS analysis result in the business, or a follow-up analysis (such as, renewing a contract) that incorporates new data to perform a comprehensive TRS analysis result and cost analysis. Moreover, the method is applicable with new technologies, newly developed rules and new data as they become available and input into the TRS data repository component. As such, the interdependencies among infrastructure, facility, business and application are readily identified and associated seamlessly and in parallel. This allows end users/owners to prioritize the requirements for a business as a situation changes or to approach the problem with different perspectives. Moreover, given that the TRS tool solicits prioritization of the information or data provided by an end user/owner, as such the TRS tool can provide a specific analysis result or proposal that is based on any priority levels or ratings set for the business and technical requirements by the end user/owner. If the priority levels or ratings are adjusted, the TRS tool will recalculate and provide an alternate optimal TRS analysis result or information technology upgrade or refresh analysis result for implementing the TRS analysis result based on the new or modified priority ratings.

In another embodiment, the invention provides a computer system for determining an optimal upgrade to an information technology infrastructure or a technology refresh solution or analysis result or an optimal TRS (Technology Refresh Services) solution or analysis when renewing and/or refreshing and/or updating and/or revising an existing information technology solution used in a business. Reference is now made to reference numeral 300 in FIG. 3, which depicts a system 300 for determining an optimal TRS solution or analysis along with corresponding operational costs for implementing the TRS solution or analysis, in accordance with an embodiment of the invention. Turning to FIG. 3, the system 300, in an embodiment, is a multi-tier computer architecture of a Technology Refresh Services (TRS) system, which includes the TRS tool 350. The TRS tool 350 comprises a TRS data repository component 310, a user interface component 306, a TRS solution analysis component 308 and a TRS cost analysis component 312. The TRS system 300 provides a controlled and a secure programming interface between each of the user interface component 306, the TRS data repository component 310, the TRS solution analysis component 308 and the TRS cost analysis component 312 as well as one or more external systems. As shown in FIG. 3, the TRS data repository component 310 is configured to receive input (factual data and business rules) from the TRS engineer or engineering team 304, as described herein above with respect to FIG. 1. In an embodiment, the TRS data repository component 310 is configured to receive automated input from the TRS engineer or engineering team 304. Further, the TRS data repository component 310 is configured to receive input, such as, business and technical data and requirements for a given business from the end user and/or owner 302 via the TRS user interface component 306. Further, each of the TRS solution analysis component 308 and the TRS cost analysis component 312 can access the TRS data repository component 310 in order to obtain any data or information and/or business rules. In particular, the information stored in the TRS data repository component 310 can be loaded into the TRS solution analysis component 308 and/or the TRS cost analysis component 312 in order to develop or generate an optimal TRS (technology refresh services) solution or analysis result along with associated calculated operational costs for implementation of the generated technology refresh services (TRS) solution or analysis results in the business.

In an embodiment, the TRS user interface component 306 is configured to elicit and capture business and/or technical requirements, data or information from the owner/end user in order to implement a technology refresh services (TRS) solution or analysis determined using the TRS tool. This information includes details about the end user's and/or owners technical and business requirements data that the TRS analysis or solution determined will need to meet. The information gathered from the owner/end user can be based on either the owners precise knowledge or the best guess knowledge or estimation of the requirements for implementing the technology refresh services (TRS) solution or analysis results. Further, the TRS user interface component 306 provides the owner and/or end user with guidance (system generated user help and variable selection recommendations) in selecting the various alternative input parameters for the business and technical data inputted or entered into the TRS tool that will have an impact on the optimal TRS solution or analysis results determined for the business as well as the corresponding operational costs for implementing the technology refresh services (TRS) solution or analysis results determined. The TRS tool 350 captures the owner's or end user's requirements via the business-technical data or variables inputted into the TRS tool 350 and allows an owner and/or end user 302 to select or assign priority levels or ratings for one or more of the business-technical data or variables inputted based on any business requirements or goals, technical requirements as well as any existing or prospective business-related constraints. Further, the user interface component 312 also conveys back to the end user and/or owner 302 any processed cost estimate analysis performed by the TRS cost analysis component 312, which in an embodiment, is invoked by the TRS solution analysis component 308.

In an embodiment, the TRS solution analysis component 308 is further configured to identify criticality for a priority level assigned by an end user/owner with respect to one or more of the business and/or technical data entered and is configured to automatically adjust a priority level assigned by an end user/owner in order to minimize inconsistencies among the business and/or technical data inputted into the TRS tool. Further, the TRS tool allows an end user/owner to update or change or adjust the inputted business and/or technical data, the priority levels or ratings assigned to any of the data inputted, business goals and/or technical requirements in order to develop an alternate optimal TRS solution or analysis with an alternate set of cost estimates, hence supporting an end user's or owner's information technology solution needs. In an embodiment, the TRS solution analysis component 308 of the TRS tool 350 processes the business-technical data or variables against business rules stored in the data repository component 310 as well as facts or data stored in the data repository component 310 in order to perform task(s) that utilize a specific tool-set. Further, the TRS tool 350 uses functions and formulas encapsulated within the cost analysis component 312 for calculating various operational costs based on a given set of end user input provided to the solution analysis component 308. The cost analysis component 308, in an embodiment, includes functions and formulas to estimate the TRS operation's costs. For instance, let f(x)=up-front setup cost (referred to herein as ‘transition’ costs) of implementing a technology refresh services (TRS) solution or analysis result, which are based on a given set of business-technical data or variables, whereas, let f(y)=cost of managing or operating the TRS solution or analysis result over time or the life cycle of the business, but excluding the transition costs (referred to herein as ‘steady state’ costs), which are based on a given set of business and/or technical data or variables. As such, the estimated proposal costs or operational costs to be incurred by an owner or end user for undertaking or implementing a TRS solution or analysis result for the life cycle of the business are estimated by f(z), where f(z)=f(x)+f(y). In an embodiment, the cost analysis component 312 includes algorithms for calculating both f(x) and f(y) to produce f(z) based on a given set of user input regarding business and/or technical data, and the facts and/or business rules entered in the data repository component 310.

In an embodiment, the TRS solution analysis component 308 of the TRS tool 350 utilizes non-monotonic reasoning, such as, an Assumptions Based Truth Maintenance System (ATMS) to develop a TRS analysis result based on available information from the data repository component or expert system 310. Accordingly, as new or contradictory information becomes available, the Technology Refresh Services (TRS) tool 350 is capable of backtracking and retracting the set of assertions, which were used to build its initial TRS configuration or analysis result, and then developing a new TRS analysis result based on the newly discovered evidence. In an embodiment, the TRS solution analysis component 308 establishes or determines an overall business goal and/or technical criteria based on the end user's/owner's business and/or technical requirements inputted into the TRS tool 350. It then creates a decision hierarchy based on all known criteria and identifies the various alternatives based on its interaction with the other sub-components 310 and 312 of the TRS tool 350. In an embodiment, the TRS solution analysis component 308 calculates all decision sub-paths within each alternative to compute the lowest cost alternative configuration that meets required goals and criteria set forth by the end user/owner. The latter computation is achieved based on an owner's or end user's criteria, facts, data, and/or business rules obtained from the data repository component 310, and the computations performed by the cost analysis component 312.

Once the user/owner changes the business requirements and/or criteria by changing any of the values for the technical and/or business data or variables previously provided, or if any of the previously asserted facts are invalidated by new facts, the solution analysis component 308 invokes the cost analysis component 312 to re-compute cost estimates and provides a new TRS configuration or analysis result to the user/owner. Accordingly, with all the business rules and data in the data repository component 310, the solution analysis component 308 processes the data and rules associated with various disciplines in parallel, where any interdependency can be resolved instantly, and opportunities in various fields can be associated and explored thoroughly to achieve the optimal TRS solution or analysis result effectively. This parallelism not only allows bypassing certain processes that Subject Matter Experts (SME) in various disciplines would need to go through, but also allows securing the opportunities that a decision maker (end user/owner) might otherwise miss. Accordingly, all the interdependencies among infrastructure, application, facility, and business requirements are readily identified and associated seamlessly in parallel, so that the right TRS solution or analysis result and associated costs are available right after the owner finishes inputting the data. Further, as an owner tunes the priority ratings on various requirements, different options can be proposed with different associated costs, which helps both a service provider and a customer approach the analysis result from different perspectives. The TRS tool 350 provides an opportunity that otherwise would be missed if the rules and data from all the disciplines are not associated together, as a group of SMEs from various disciplines would not necessarily have all the pertinent data in order to thoroughly and systematically go through a what-if analysis and to consider all related data and rules synchronously.

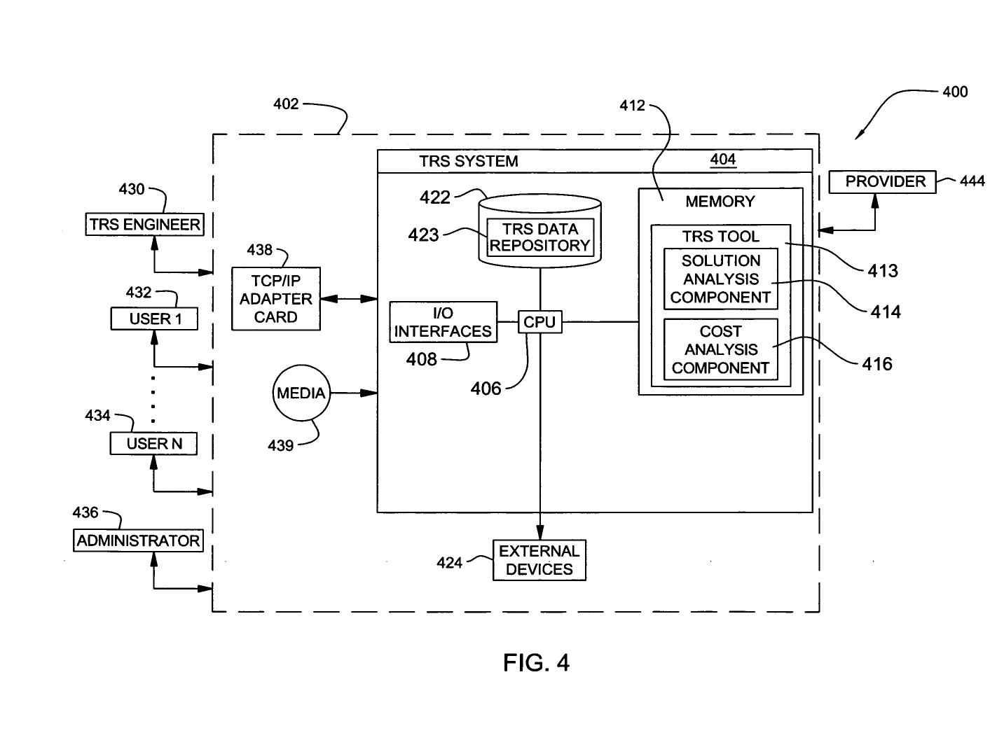

Referring now to FIG. 4, there is illustrated a system 400 that provides a computer program product for determining an optimal upgrade to an information technology infrastructure or a technology refresh solution or analysis result for implementation in a business, when renewing and/or refreshing and/or updating and/or revising and/or upgrading an existing information technology solution, in accordance with an embodiment of the present invention. The computer program product comprises a computer readable or computer-usable medium, which provides program code, namely, the technology refresh services (TRS) tool 413, for use by or in connection with a computer or any instruction execution system. The TRS tool or program 413 can be loaded into computer system 404 from a computer readable media 439, such as, a magnetic tape or disk, optical media, DVD, memory stick, semiconductor memory, etc. or downloaded from the Internet via a TCP/IP adapter card 438. As depicted in FIG. 4, system 400 includes a computer infrastructure 402, which is intended to represent any type of computer architecture that is maintained in a secure environment (i.e., for which access control is enforced). As shown, infrastructure 402 includes a TRS (technology refresh services) system 404 that typically represents a server or system 404 or the like that includes a TRS tool or program 413 configured to determine an optimal TRS solution or analysis result for implementation into a business when renewing and/or refreshing and/or updating and/or revising and/or upgrading an existing information technology solution. It should be understood, however, that although not shown, other hardware and software components (e.g., additional computer systems, routers, firewalls, etc.) could be included in infrastructure 402.

In general, user 1 (reference numeral 432) through user N (reference numeral 434) may access the server or system 404, which has deployed thereon the TRS tool 413, which implements the invention. The TRS tool or program 413 is run on the TRS system or server 404 and is configured to determine an optimal TRS solution or analysis result for the business. In an embodiment, the TRS tool 413 comprises a solution analysis component 414, a cost analysis component 416. Further, in an embodiment, the technology refresh services (TRS) system 404 includes a database storage 422, which comprises a TRS data repository 423 that contains relevant business and technical data and/or business rules used by the technology refresh services (TRS) tool for determining an optimal TRS solution or analysis result for the business. It is understood that although the TRS data repository 423 is shown as stored in a storage 422, can be stored in local memory 412 within system 404.

As shown in FIG. 4, a user (user 1, reference numeral 432 through user N, reference numeral 432) accesses the TRS server or system 404 over a network via interfaces (e.g., web browsers) loaded on a client, for example, a personal computer, a laptop, a handheld device, etc. In the case of the latter, the network can be any type of network such as the Internet, a local area network (LAN), a wide area network (WAN), a virtual private network (VPN), etc. In any event, communication with infrastructure 402 could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, the parties could utilize an Internet service provider to establish connectivity to infrastructure 402. It should be understood that under the present invention, infrastructure 402 could be owned and/or operated by a party such as provider 444, or by an independent entity. Regardless, use of infrastructure 402 and the teachings described herein could be offered to the parties on a subscription or fee-basis. In either scenario, an administrator 436 could support and configure infrastructure 402, for instance, upgrading the TRS tool 413 in the TRS server or system 404.

The TRS system or server 404 is shown to include a CPU (hereinafter “processing unit 406”), a memory 412 and a user interface 408. In general, processing unit 406 executes computer program code, such as the TRS tool 413. While executing computer program code or the TRS tool 413, the processing unit 406 can read and/or write data to/from memory 412, file system or database 422 and the user interface 408. For instance, in one embodiment, the TRS tool 413 stores a copy of any TRS data and or data rules in the TRS data repository 423 in the storage 422. Alternatively, the TRS data repository 423 may be stored in a separate storage within the TRS system 404. Bus 410 provides a communication link between each of the components in computer system 400, such that information can be communicated within the infrastructure 402. Further, the TRS server 404 is shown in communication with external devices 424. External devices 424 can comprise any devices (e.g., keyboard, pointing device, display, etc.) that enable a user to interact with computer system 400 and/or any devices (e.g., network card, modem, etc.) that enable TRS server 404 to communicate with one or more other computing devices.

Computer infrastructure 402 is only illustrative of various types of computer infrastructures for implementing the invention. For example, in an embodiment shown, computer infrastructure 402 comprises two or more computing devices (e.g., a server cluster) that communicate over a network to perform the various process steps of the invention. Moreover, computer system 400 is only representative of various possible computer systems that can include numerous combinations of hardware. To this extent, in other embodiments, computer system 400 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 406 may comprise a single processing unit, or be distributed across one or more processing units in one or more locations, e.g., on a client and server. Similarly, memory 412 and/or file system 422 can comprise any combination of various types of data storage and/or transmission media that reside at one or more physical locations. Further, I/O interfaces 408 can comprise any system for exchanging information with one or more external devices 424. Still further, it is understood that one or more additional components (e.g., system software, math co-processing unit, etc.) not shown in FIG. 4 can be included in computer system 400. However, if computer system 400 comprises a handheld device or the like, it is understood that one or more external devices 424 (e.g., a display) and/or file system(s) 422 could be contained within computer system 404, and not externally as shown. File system 422 can be any type of system (e.g., a database) capable of providing storage for information under the present invention, such as the files to be preprocessed by the TRS tool 413. To this extent, file system 422 could include one or more storage devices, such as a magnetic disk drive or an optical disk drive. In another embodiment, file system 422 includes data distributed across, for example, a local area network (LAN), wide area network (WAN) or a storage area network (SAN) (not shown). Although not shown, additional components, such as cache memory, communication systems, system software, etc., may be incorporated into computer system 400.

The foregoing descriptions of specific embodiments of the present invention have been presented for the purpose of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of using a computing system to determine an optimal upgrade to an information technology infrastructure for implementation in a business, said method comprising the steps of:
storing, in a data repository within a computing system, a plurality of business rules and a plurality of business-technical data that are inputted into said computing system for an information technology infrastructure used in a business;
updating one or more of said plurality of business rules and said plurality of business-technical data stored in said data repository within said computing system to determine an optimal upgrade to said information technology infrastructure;
prioritizing one or more of said plurality of business-technical data updated in said data repository based on one or more business-technical requirements, including any existing business constraints and any prospective business constraints;
determining said optimal upgrade to said information technology infrastructure, using said plurality of business rules updated in said data repository and using said plurality of business-technical data updated in said data repository, wherein said optimal upgrade to said information technology infrastructure determined can be implemented in said business.

2. The method according to claim 1, further comprising the step of:
calculating, using said computer system, an estimation of operational costs for implementing said optimal upgrade to said information technology infrastructure determined.

3. The method according to claim 2, further comprising the step of:
generating one or more operational cost estimation reports based on said estimation of operational costs calculated for implementing said optimal upgrade to said information technology infrastructure determined for said business.

4. The method according to claim 3, wherein said storing step further comprises the steps of:
deploying on said computer system an information technology upgrade analysis tool configured to determine said optimal upgrade to said information technology infrastructure, said information technology upgrade analysis tool including said data repository; and
inputting into said data repository said plurality of business rules and said plurality of business-technical data for said information technology infrastructure used in said business.

5. The method according to claim 4, wherein said determining step further comprises the steps of:
loading said plurality of business-technical data updated and said plurality of business rules updated into a first analysis component of said information technology upgrade analysis tool deployed on said computing system for determining said optimal information technology upgrade to said information technology infrastructure; and
running an analysis, using said first analysis component of said information technology upgrade analysis tool deployed on said computing system for determining said optimal upgrade to said information technology infrastructure for implementation in said business.

6. The method according to claim 5, wherein said determining step further comprises the steps of:
re-prioritizing said one or more of said plurality of business-technical data updated in said data repository; and
re-running an alternate analysis, using said first analysis component of said information technology upgrade analysis tool deployed on said computing system for determining an alternative optimal upgrade to said information technology infrastructure for implementation in said business.

7. The method according to claim 6, wherein said calculating step further comprises the steps of:
inputting, into a second analysis component of said information technology upgrade analysis tool deployed on said computing system, cost estimation data for said information technology infrastructure used in said business;
inputting, into said second analysis component of said information technology upgrade analysis tool deployed on said computing system, any additional cost estimation data for said optimal upgrade to said information technology infrastructure determined for said business; and
using said cost estimation data and said any additional cost estimation data for calculating said estimation of operational costs for implementing said optimal upgrade to said information technology infrastructure for implementation in said business.

8. The method according to claim 7, wherein said plurality of business-technical data comprises at least one of: cost, performance, network bandwidth, length of equipment lease streams, license costs, transaction volumes, input/output requirements, CPU and processing requirements, floor space requirements, power requirements, server consolidation requirements, and ability to effectively execute said optimal upgrade to said information technology infrastructure; and wherein said business-technical requirements comprises at least one of: current server CPU, current memory, current disk storage, current network interface configuration, current test environment, current production environment, minimal server CPU, optimal server CPU, minimal memory, optimal memory, minimal disk storage, optimal disk storage, minimal network interface configuration, optimal network interface configuration, application software configuration on a server, middleware package configuration on said server, system software configuration on said server, version, release and license type for operating system on said server, version, release and license type for each application software package, version, release and license type for each middleware package, version, release and license type for each system software package; anticipated application usage peak hours, anticipated application usage peak days, anticipated application usage special pattern, anticipated application usage peak to average ratio of application usage, criticality of application, population of users, location of users, type of network connection used by users to access said application, anticipated growth of application usage at different times, location of data center where said server will be placed, type of service offerings to be used, type of infrastructure models that an application will use, desired date that said optimal upgrade to said information technology infrastructure needs to be implemented and desired formats for said operational cost estimation reports.

9. A system for determining an optimal upgrade to an information technology infrastructure for implementation in a business, comprising:
an information technology upgrade analysis tool configured to determine an optimal upgrade to an information technology infrastructure for implementation in a business, said information technology upgrade analysis tool comprising:
a user interface component configured to receive input from an end user as to a plurality of business-technical data associated with said business, one or more of said plurality of business-technical data inputted being prioritized by said end user based on one or more business-technical requirements, including any existing business constraints and any prospective business constraints, said user interface component being further configured to receive input as to a plurality of business rules used in said business;
a data repository component configured to store said plurality of business-technical data received from said end user, said data repository component being further configured to store said plurality of business rules used in said business;
a first analysis component configured to determine said optimal upgrade to said information technology infrastructure for implementation in said business using said business-technical data inputted and prioritized by said end user and using said business-technical requirements inputted for said business; and
a second analysis component configured to calculate corresponding operational costs for said optimal upgrade to said information technology infrastructure determined by said first analysis component using said business-technical data and said business rules stored in said data repository component; wherein said information technology upgrade analysis tool is configured to provide a controlled and a secure programming interface between each of said user interface component, said data repository component, said first analysis component, said second analysis component and one or more external systems.

10. The system according to claim 9, wherein said first analysis component is further configured to utilize an assumption based truth maintenance system for determining said optimal upgrade to said information technology infrastructure that can be implemented in said business, said first analysis component being configured to backtrack an initial set of assertions used in determining said optimal upgrade to said information technology infrastructure for determining an alternate optimal upgrade to said information technology infrastructure.

11. The system according to claim 10, wherein said first analysis component is further configured to identify criticality for one or more of said plurality of business-technical data inputted by said end user based on said one or more business-technical requirements used to prioritize said one or more of said plurality of business-technical data in order to determine said optimal upgrade to said information technology infrastructure for implementation in said business.

12. The system according to claim 11, wherein said data repository component is further configured to receive updates for said plurality of business-technical data and for said business rules stored therein.

13. The system according to claim 12, wherein said second analysis component is further configured to calculate said corresponding operational costs using functions and formulas that calculate transition costs and steady state costs associated with said optimal upgrade to said information technology infrastructure for implementation in said business.

14. The system according to claim 13, wherein said plurality of business-technical data comprises at least one of: cost, performance, network bandwidth, length of equipment lease streams, license costs, transaction volumes, input/output requirements, CPU and processing requirements, floor space requirements, power requirements, server consolidation requirements, and ability to effectively execute said optimal upgrade to said information technology infrastructure; and wherein said business-technical requirements comprises at least one of, current server CPU, current memory, current disk storage, current network interface configuration, current test environment, current production environment, minimal server CPU, optimal server CPU, minimal memory, optimal memory, minimal disk storage, optimal disk storage, minimal network interface configuration, optimal network interface configuration, application software configuration on a server, middleware package configuration on said server, system software configuration on said server, version, release and license type for operating system on said server, version, release and license type for each application software package, version, release and license type for each middleware package, version, release and license type for each system software package; anticipated application usage peak hours, anticipated application usage peak days, anticipated application usage special pattern, anticipated application usage peak to average ratio of application usage, criticality of application, population of users, location of users, type of network connection used by users to access said application, anticipated growth of application usage at different times, location of data center where said server will be placed, type of service offerings to be used, type of infrastructure models that an application will use, desired date that said optimal upgrade to said information technology infrastructure needs to be implemented and desired formats for said operational cost estimation reports.

15. A computer program product for determining an optimal upgrade to an information technology infrastructure for implementation in a business, said computer program product comprising:
a computer readable medium;
first program instructions to store input data into a data repository within a computing system, said input data including a plurality of business-technical data and business rules;
second program instructions to select a priority rating for one or more of said plurality of business-technical data based on one or more business-technical requirements for said business, including any existing business constraints and any prospective business constraints;
third program instructions to determine an optimal upgrade to an information technology infrastructure using said priority rating selected for said one or more of said plurality of business-technical data and using said plurality of business rules updated in said data repository and to calculate an estimation of operational costs for implementing in said business said optimal upgrade to said information technology infrastructure determined; and wherein said first, second and third program instructions are recorded on said computer readable medium.

16. The computer program product according to claim 15, further comprising:
fourth program instructions to generate reports to an end user itemizing said optimal upgrade to said information technology infrastructure determined and to generate reports for said estimation of operational costs calculated for implementing said optimal upgrade to said information technology infrastructure determined in said business; said fourth program instructions being recorded on said computer readable medium.

17. The computer program product according to claim 16, wherein said first program instructions include instructions to update said plurality of business rules stored in said data repository; and wherein said first program instructions include instructions to update one or more of said plurality of business-technical data stored in said data repository.

18. The computer program product according to claim 17, wherein said second program instructions include instructions to automate adjustments to said priority ratings selected when any inconsistencies are detected among said priority rating selected for said one or more of said plurality of business-technical data for determining said optimal upgrade to said information technology infrastructure for implementation in said business.

19. The computer program product according to claim 18, wherein said third program instructions include instructions to backtrack an initial set of assertions used in determining said optimal upgrade to said information technology infrastructure and to re-determine an alternate optimal upgrade to said information technology infrastructure for implementation in said business when any adjustments are made to said priority ratings selected for said one or more of said plurality of business-technical data and to re-calculate a corresponding alternate estimation of operational costs for implementation of said alternate optimal upgrade to said information technology infrastructure in said business.

20. The computer program product according to claim 19, wherein said plurality of business-technical data comprises at least one of: cost, performance, network bandwidth, length of equipment lease streams, license costs, transaction volumes, input/output requirements, CPU and processing requirements, floor space requirements, power requirements, server consolidation requirements, and ability to effectively execute said optimal upgrade to said information technology infrastructure; and wherein said business-technical requirements comprises at least one of: current server CPU, current memory, current disk storage, current network interface configuration, current test environment, current production environment, minimal server CPU, optimal server CPU, minimal memory, optimal memory, minimal disk storage, optimal disk storage, minimal network interface configuration, optimal network interface configuration, application software configuration on a server, middleware package configuration on said server, system software configuration on said server, version, release and license type for operating system on said server, version, release and license type for each application software package, version, release and license type for each middleware package, version, release and license type for each system software package; anticipated application usage peak hours, anticipated application usage peak days, anticipated application usage special pattern, anticipated application usage peak to average ratio of application usage, criticality of application, population of users, location of users, type of network connection used by users to access said application, anticipated growth of application usage at different times, location of data center where said server will be placed, type of service offerings to be used, type of infrastructure models that an application will use, desired date that said optimal upgrade to said information technology infrastructure needs to be implemented and desired formats for said operational cost estimation reports.
